(19) United States
(12) Patent Application Publication
(10) Pub. No.: US 2013/0145402 A1
(43) Pub. Date: Jun. 6, 2013

(54) VIDEO ON DEMAND BROADCAST SERVICES

(71) Applicants: Lalit R. KOTECHA, San Ramon, CA (US); Sergio AGUIRRE, Southlake, TX (US)

(72) Inventors: Lalit R. KOTECHA, San Ramon, CA (US); Sergio AGUIRRE, Southlake, TX (US)

(73) Assignee: VERIZON PATENT AND LICENSING INC., Basking Ridge, NJ (US)

(21) Appl. No.: 13/310,052

(22) Filed: Dec. 2, 2011

(51) Int. Cl. H04N 7/16; H04W 72/04

(52) U.S. Cl. 725/62

(57) ABSTRACT

A system may include one or more devices. The one or more devices may obtain indications of quantities of wireless resources that are available at a group of wireless transmission devices, and determine, based on the obtained indications, an amount of wireless resources to allocate to a broadcast service that provides video on demand content. The one or more devices may further cause the determined amount of wireless resources to be allocated, from a unicast service, to the broadcast service at one or more wireless transmission devices, of the group of wireless transmission devices.

### BACKGROUND

Evolved multimedia broadcast multicast services (eMBMS) include a point-to-multipoint (PMP) interface specification for existing and upcoming Third Generation Partnership Project (3GPP) cellular networks. eMBMS are designed to provide efficient delivery of broadcast and multicast services.

### BRIEF DESCRIPTION OF THE DRAWINGS

FIGS. 1A and 1B are diagrams illustrating an overview of an example implementation described herein;

FIG. 2 is a diagram of an example environment in which systems and/or methods described herein may be implemented;

FIG. 3 is a diagram of example components of an eNodeB of FIG. 2;

FIG. 4 is a diagram of example functional components of the eNodeB of FIG. 2;

FIG. 5 is a diagram of example components of a device that may correspond to one of the components of the environment of FIG. 2;

FIG. 6 is a diagram of example functional components of the video on demand (VOD) scheduler of FIG. 2;

FIG. 7 is a diagram of example functional components of the Broadcast Video Provisioning System (BVPS) of FIG. 2;

FIG. 8 is a diagram of a flow chart of an example process for configuring an eNodeB to provide VOD broadcast services;

FIG. 9 is a diagram of a flow chart of another example process for configuring an eNodeB to provide VOD broadcast services; and

FIGS. 10A-10F are diagrams illustrating an example of the process of FIG. 9.

### DETAILED DESCRIPTION OF PREFERRED EMBODIMENTS

The following detailed description refers to the accompanying drawings. The same reference numbers in different drawings may identify the same or similar elements.

Systems and/or methods described herein may provide video on demand (VOD) broadcast services in a wireless environment. The VOD broadcast services may be provided to a target service area, based on the quantity of wireless resources that is available in the target service area.

While the following description focuses on the 3GPP Long Term Evolution (LTE) standard, it will be appreciated that systems and/or methods, described herein, are equally applicable to other wireless standards.

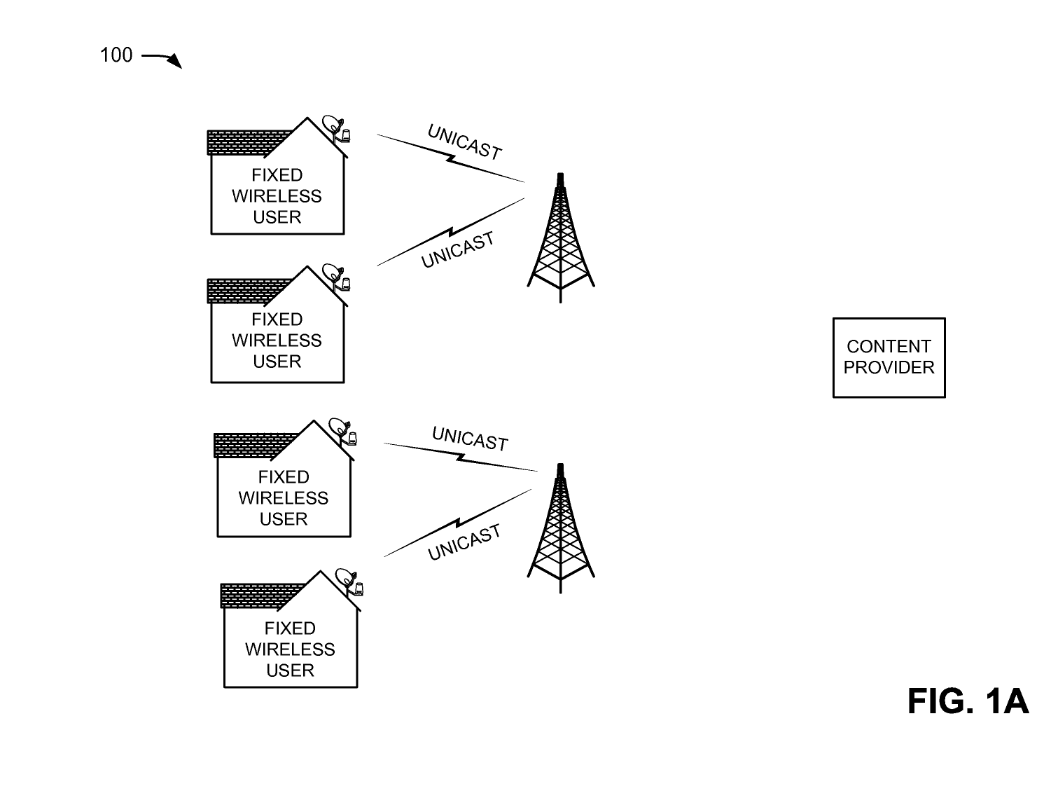

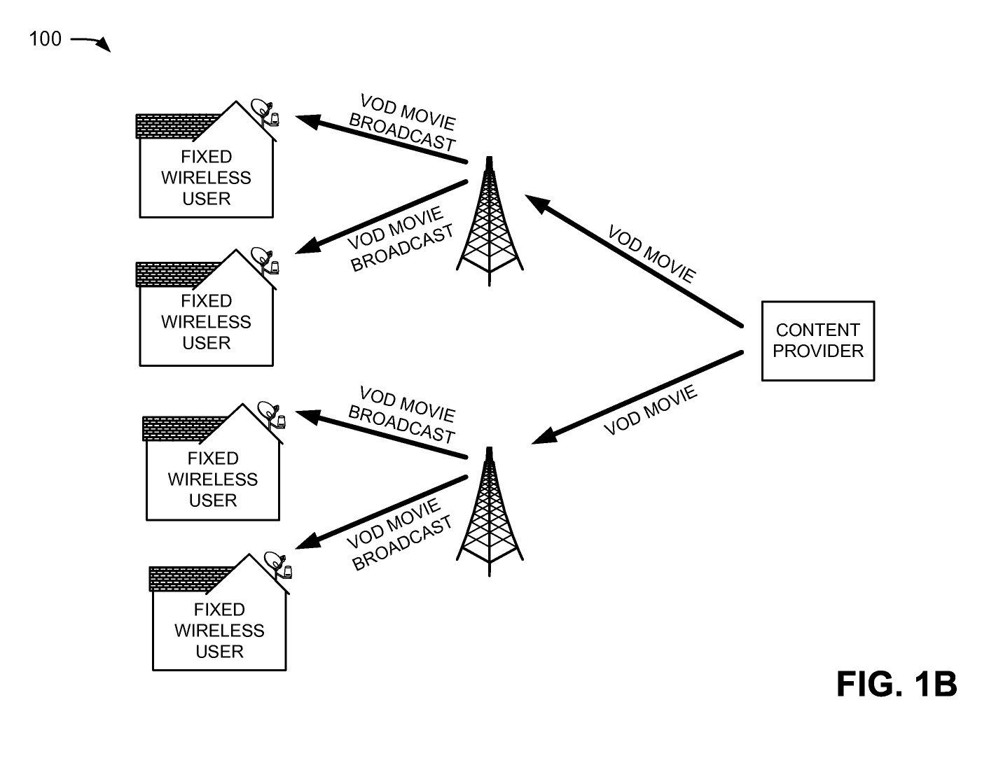

FIGS. 1A and 1B are diagrams illustrating an overview of an example implementation 100 described herein. Assume, for example implementation 100, that a group of fixed wireless users receive unicast services from a group of eNodeBs in a network, as illustrated in FIG. 1A. The term “fixed wireless” may refer to wireless devices or systems that are situated in fixed locations, such as, for example, an office or home. The network may monitor the availability of radio resources at the eNodeBs. Moreover, the network may obtain information from the group of fixed wireless users. Based on the radio resource availability of the eNodeBs and possibly based on the information received from the fixed wireless users, the network may provision the eNodeBs to provide VOD broadcast services (e.g., according to the evolved Multimedia Broadcast/Multicast Service (eMBMS) standards), as illustrated in FIG. 1B. Upon receipt, the VoD broadcast services may be viewed instantly by the fixed wireless users. In other instances, the fixed wireless users may store the VOD content that is being broadcast for later viewing.

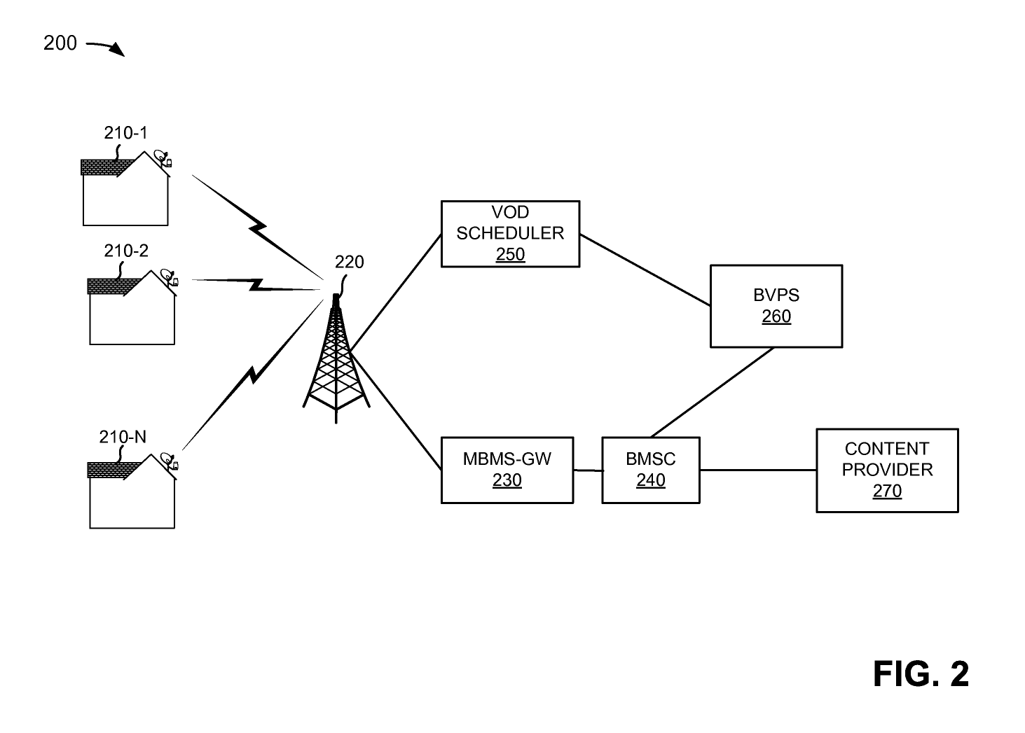

FIG. 2 is a diagram of an example environment 200 in which systems and/or methods described herein may be implemented. As illustrated, environment 200 may include a group of customer premises 210-1 through 210-N (where N>1) (which may be referred to collectively and individually as “customer premises 210”), an eNodeB 220, a Multimedia Broadcast/Multicast Service Gateway (MBMS-GW) 230, a Broadcast/Multicast Services Center (BMSC) 240, a VOD scheduler 250, a Broadcast Video Provisioning System (BVPS) 260, and a content provider 270. Components of environment 200 may interconnect via wired and/or wireless connections. For example, customer premises 210 may wirelessly connect to one or more eNodeBs 220. MBMS-GW 230, BMSC 240, VOD scheduler 250, BVPS 260, and content provider 270 may interconnect via wired and/or wireless connections.

Customer premises 210 may include one or more fixed wireless devices that are capable of wirelessly receiving broadcast content from eNodeB 220. For example, customer premises 210 may include a personal computer, a laptop computer, a set-top box, a gaming console, and/or other types of devices that are capable of receiving broadcast content from eNodeB 220. These devices may, for example, receive the broadcast content via an integrated LTE modem, an indoor fixed wireless terminal integrated with wireless router capability, an outdoor (rooftop installation) LTE modem with Ethernet cable, or an outdoor antenna connected via coaxial cable to an indoor LTE modem.

In one example implementation, customer premises 210 may include a device that stores an application/middleware to support an electronic service guide (ESG) with programming information. A user may interact with the ESG to select VOD content for viewing. Moreover, customer premises 210 may include a device that may record VOD content for later viewing.

eNodeB 220 may include one or more wireless transmission devices that provide unicast and broadcast services to customer premises 210. For example, eNodeB 220 may include one or more devices that wirelessly receive information (e.g., video, voice, data, etc.) from customer premises 210 and transmit that information to other components in environment 200, including other customer premises 210. eNodeB 220 may also include one or more devices that receive VOD content from content provider 270 and wirelessly transmit that VOD content to customer premises 220 as part of a broadcast service. eNodeB 220 may further include one or more devices that provide the ESG to customer premises 210 as part of the broadcast service. Moreover, eNodeB 220 may periodically provide updates to the ESG to reflect the latest available programming. In one example, eNodeB 220 may push the ESG to customer premises 210 (e.g., in a one-way communication). In another example, eNodeB 220 may provide two-way broadcast communication that allows information, from customer premises 210, to be collected. eNodeB 220 may additionally include one or more devices that forwards information, received from customer premises 210, to VOD scheduler 250, to allow VOD scheduler 250 to make VOD scheduling decisions.

MBMS-GW 230 may include one or more devices that gather, process, and/or provide information in a manner described herein. For example, MBMS-GW 230 may include a server device or another type of network device. In an example implementation, MBMS-GW 230 may include a point-to-multipoint interface that provides delivery of broadcast services to one or more eNodeBs 220.

BMSC 240 may include one or more devices that gather, process, and/or provide information in a manner described herein. For example, BMSC 240 may include a server device or another type of network device. In an example implementation, BMSC 240 may obtain, from BVPS 260, information identifying VOD content to be broadcast and cause the VOD content to be provided, from content provider 270, to MBMS-GW 230.

VOD scheduler 250 may include one or more devices that gather, process, and/or provide information in a manner described herein. For example, VOD scheduler 250 may include a server device or another type of network device. In an example implementation, VOD scheduler 250 may receive radio resource availability information from eNodeB 220 and make VOD broadcast decisions based on the received radio resource availability information. VOD scheduler 250 may also receive information from customer premises 210 and use that information as part of the VOD broadcast decision.

BVPS 260 may include one or more devices that gather, process, and/or provide information in a manner described herein. For example, BVPS 260 may include a server device or another type of network device. In an example implementation, BVPS 260 may receive information associated with scheduling VOD content for broadcast delivery, from VOD scheduler 250, and may configure eNodeB 220 for the VOD broadcast. BVPS 260 may provide information, identifying the VOD content, to BMSC 240 to allow BMSC 240 to obtain the VOD content from content provider 270.

Content provider 270 may include one or more devices that gather, process, and/or provide information in a manner described herein. In one example, content provider 270 may include a computer system, an application, a cable head-end, and/or a broadcasting device capable of providing VOD content. Content provider 270 may provide VOD content from a satellite feed, a cable television feed, an Internet content store, and/or from another source.

Although FIG. 2 shows example components of environment 200, in other implementations, environment 200 may include fewer components, different components, differently arranged components, or additional components than those depicted in FIG. 2. For example, environment 200 may additionally include one or more mobile devices (e.g., smartphones, tablet computers, etc.) that may receive VOD content. Additionally, or alternatively, one or more components of environment 200 may perform one or more tasks described as being performed by one or more other components of environment 200.

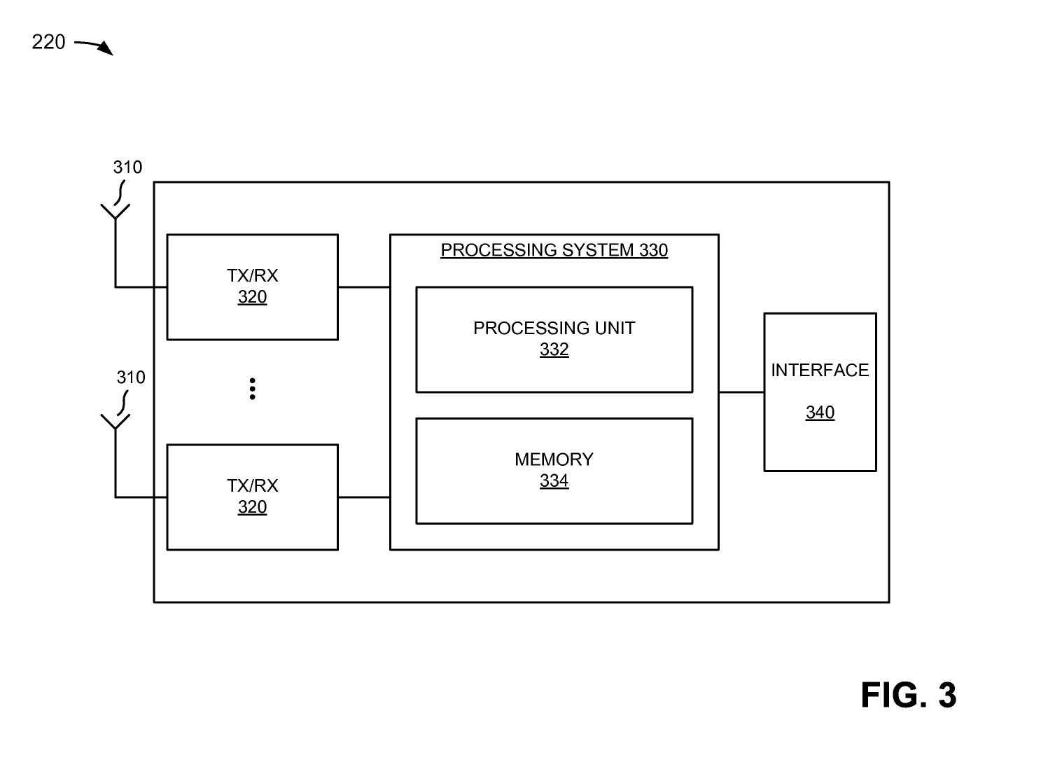

FIG. 3 is a diagram of example components of eNodeB 220. As shown in FIG. 3, eNodeB 220 may include antennas 310, transceivers (TX/RX) 320, a processing system 330, and an interface 340.

Antennas 310 may include one or more directional and/or omni-directional antennas. Transceivers 320 may be associated with antennas 310 and may include transceiver circuitry for transmitting and/or receiving symbol sequences in a network via antennas 310.

Processing system 330 may control the operation of eNodeB 220. Processing system 330 may also process information received via transceivers 320 and/or interface 340. As illustrated in FIG. 3, processing system 330 may include a processing unit 332 and a memory 334. Processing unit 332 may include one or more processors, microprocessors, application specific integrated circuits (ASICs), field programmable gate arrays (FPGAs), or the like. Processing unit 332 may process information received via transceivers 320 and/or interface 340. In addition, processing unit 332 may transmit control messages and/or data messages, and may cause those control messages and/or data messages to be transmitted via transceivers 320 and/or interface 340. Processing unit 332 may also process control messages and/or data messages received from transceivers 320 and/or interface 340. Memory 334 may include a random access memory (RAM), a read-only memory (ROM), and/or another type of memory to store data and instructions that may be used by processing unit 332.

Interface 340 may include one or more line cards (or one or more other types of components) that allow eNodeB 220 to transmit data to and/or receive data from another eNodeB 220, MBMS-GW 230, and/or VOD scheduler 250. In one example, interface 340 may enable eNodeB 220 to provide resource availability information and, possibly, information from customer premises 210, to VOD scheduler 250. Additionally, interface 340 may receive VOD content from MBMS-GW 230 for broadcasting to customer premises 210.

As described herein, eNodeB 220 may perform certain operations in response to processing unit 332 executing software instructions contained in a computer-readable medium, such as memory 334. A computer-readable medium may be defined as a non-transitory memory device. A memory device may include memory space within a single physical memory device or spread across multiple physical memory devices. The software instructions may be read into memory 334 from another computer-readable medium or from another device via antennas 310 and transceivers 320. The software instructions contained in memory 334 may cause processing unit 332 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows example components of eNodeB 220, in other implementations, eNodeB 220 may include fewer components, different components, differently arranged components, or additional components than those depicted in FIG. 3. Additionally, or alternatively, one or more components of eNodeB 220 may perform one or more tasks described as being performed by one or more other components of eNodeB 220.

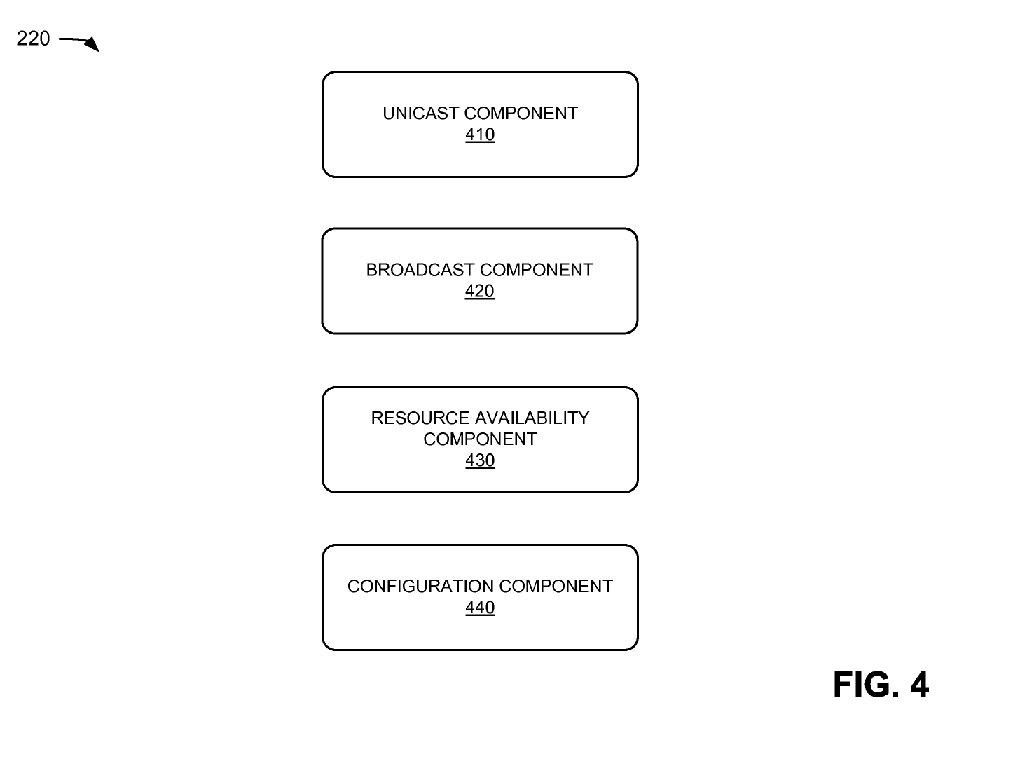

FIG. 4 is a diagram of example functional components of eNodeB 220. Each of the functional blocks, shown in FIG. 4, may be implemented by one or more of the components described with regard to FIG. 3 (e.g., by processing unit 332 executing instructions stored in memory 334). As shown in FIG. 4, eNodeB 220 may include a unicast component 410, a broadcast component 420, a resource availability component 430, and a configuration component 440.

Unicast component 410 may cause eNodeB 220 to provide unicast services to customer premises 210. The unicast services may include providing voice and/or data services to individual devices of customer premises 210. For example, unicast component 410 may allow a laptop computer, within customer premises 210, to send an email, surf the Internet, conduct a voice over Internet Protocol (VoIP) call, etc.

Broadcast component 420 may cause eNodeB 220 to provide broadcast services to a group of customer premises 210. The broadcast services may include the broadcasting of VOD content to the group of customer premises 210 that are serviced by eNodeB 220. For example, broadcast component 420 may allow a set-top box, within the group of customer premises 210, to receive, store, and provide for display a movie being broadcast by eNodeB 220.

Broadcast component 420 may also receive information from customer premises 210 and provide that information to VOD scheduler 250. The information may include, for example, marketing data and/or network information. The marketing data may include information relating to VOD content that is available to customer premises 210. For example, the marketing data may include information indicating selections (or ordering) of VOD content, ratings of VOD content, and/or any other type of information that may allow VOD scheduler 250 to determine whether particular VOD content is to be broadcast and the radio resources that should be dedicated to broadcasting the particular VOD content. The network information may include, for example, a quantity of customer premises 210, served by eNodeB 220, that have ordered particular VOD content and/or information relating to the radio signals provided to customer premises 210. For example, a customer premises 210 may provide, to eNodeB 220, received signal strength indication (RSSI) information, reference signal received power (RSRP) information, signal to Interference-plus-noise ratio (SINR) information, and/or other network information that could be used by VOD scheduler 250 to determine whether a particular eNodeB 220 should provide VOD broadcast services.

Resource availability component 430 may determine the amount of radio resources available at eNodeB 220. In one example, resource availability component 430 may determine the radio resources being used by customer premises 210 (and any mobile users in the service area of eNodeB 220). Resource availability component 430 may subtract the determined amount of radio resources being used by a maximum amount of radio resources available to eNodeB 220 to obtain an amount of available radio resources at eNodeB 220. In one example implementation, resource availability component 430 may determine the amount of available radio resources as a percentage. For example, if resource availability component 430 determines that 40% of eNodeB 220's radio resources are being used, resource availability component 430 may determine that 60% of eNodeB 220's radio resources are available.

In one example implementation, resource availability component 430 may determine the amount of radio resources that are available at eNodeB 220 as an average amount over a time period. For example, resource availability component 430 may determine first radio resource availability amounts (e.g., as percentages) every minute. Then, every 5 minutes, for example, resource availability component 430 may average the first radio resource availability amounts from the preceding 5 minutes to obtain the amount of radio resources that are available at eNodeB 220. The time period at which resource availability component 430 determines the first radio resource amounts (which may be on the order of seconds, minutes, or hours) and the time period at which resource availability component 430 determines the radio resource amount from the first radio resource amounts (which may be on the order of minutes or hours) may be configurable by a network operator.

Resource availability component 430 may transmit information, indicating the amount of available radio resources, to VOD scheduler 250. In one example, resource availability component 430 may make the resource availability determination and transmit that information to VOD scheduler 250 at a periodic interval. In one implementation, the periodic interval may be on the order of minutes or hours. Other periodic intervals are possible. Moreover, the period interval may be configurable by a network operator.

Configuration component 440 may receive a configuration profile from BVPS 260 and may configure eNodeB 220 based on the received configuration profile. For example, assume that a configuration profile indicates that eNodeB 220 is to broadcast a particular movie from 9 pm to 11 pm at a particular data rate. Configuration component 440 may receive the configuration profile and instruct broadcast component 420 to begin broadcasting the particular movie at 9 pm at the particular data rate. At 11 pm, configuration component 440 may allocate the radio resources, that were allocated to broadcasting the particular movie, to providing unicast services.

Although FIG. 4 shows example functional components of eNodeB 220, in other implementations, eNodeB 220 may include additional functional components, different functional components, and/or fewer functional components than those depicted in FIG. 4. Additionally, or alternatively, one or more functional components of eNodeB 220 may perform one or more tasks described as being performed by one or more other functional components of eNodeB 220.

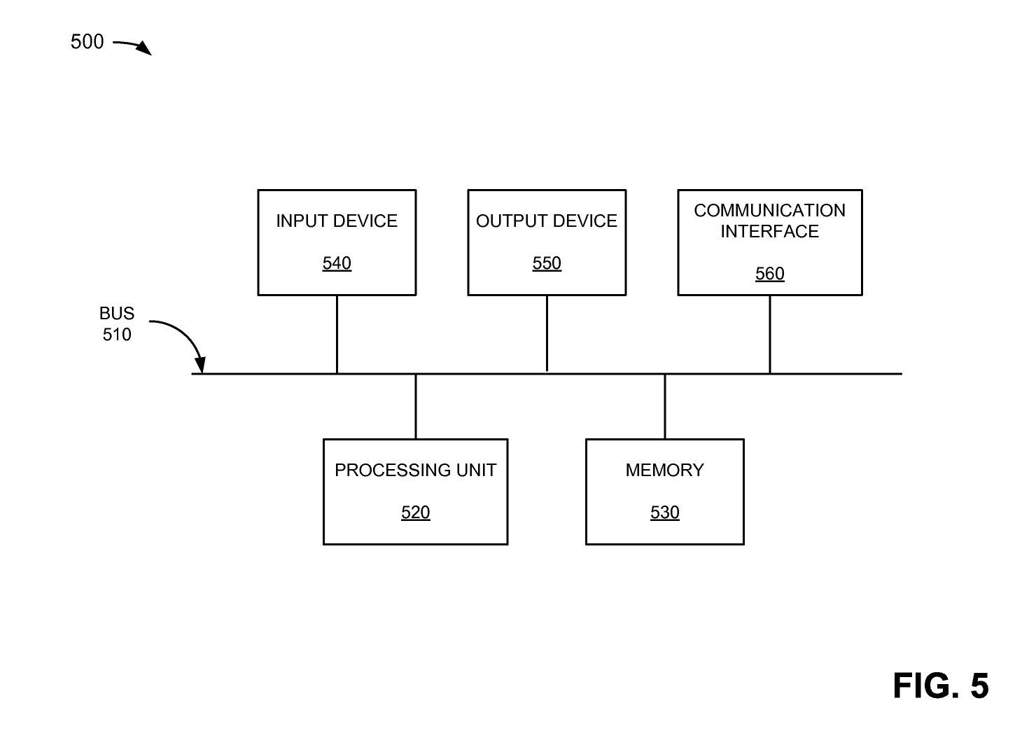

FIG. 5 is a diagram of example components of a device 500 that may correspond to one of the components of environment 200. For example, device 500 may correspond to a device in customer premises 210, MBMS-GW 230, BMSC 240, VOD scheduler 250, BVPS 260, and/or content provider 270. In one example implementation, one or more of the components of environment 200 may include one or more devices 500 or one or more components of device 500. As illustrated in FIG. 5, device 500 may include a bus 510, a processing unit 520, a memory 530, an input device 540, an output device 550, and a communication interface 560.

Bus 510 may permit communication among the components of device 500. Processing unit 520 may include one or more processors or microprocessors that interpret and execute instructions. Additionally, or alternatively, processing unit 520 may be implemented as or include one or more ASICs, FPGAs, or the like.

Memory 530 may include a RAM or another type of dynamic storage device that stores information and instructions for execution by processing unit 520, a ROM or another type of static storage device that stores static information and instructions for processing unit 520, and/or some other type of magnetic or optical recording medium and its corresponding drive for storing information and/or instructions.

Input device 540 may include a device that permits an operator to input information to device 500, such as a keyboard, a keypad, a mouse, a pen, a microphone, a touch screen display, a biometric mechanism, and the like. Output device 550 may include a device that outputs information to the operator, such as a display, a speaker, etc.

Communication interface 560 may include any transceiver-like mechanism that enables device 500 to communicate with other devices and/or systems. For example, communication interface 560 may include mechanisms for communicating with other devices, such as other components of environment 200.

As described herein, device 500 may perform certain operations in response to processing unit 520 executing software instructions contained in a computer-readable medium, such as memory 530. The software instructions may be read into memory 530 from another computer-readable medium or from another device via communication interface 560. The software instructions contained in memory 530 may cause processing unit 520 to perform processes described herein. Additionally, or alternatively, hardwired circuitry may be used in place of or in combination with software instructions to implement processes described herein. Thus, implementations described herein are not limited to any specific combination of hardware circuitry and software.

Although FIG. 5 shows example components of device 500, in other implementations, device 500 may include fewer components, different components, differently arranged components, or additional components than depicted in FIG. 5. Additionally, or alternatively, one or more components of device 500 may perform one or more tasks described as being performed by one or more other components of device 500.

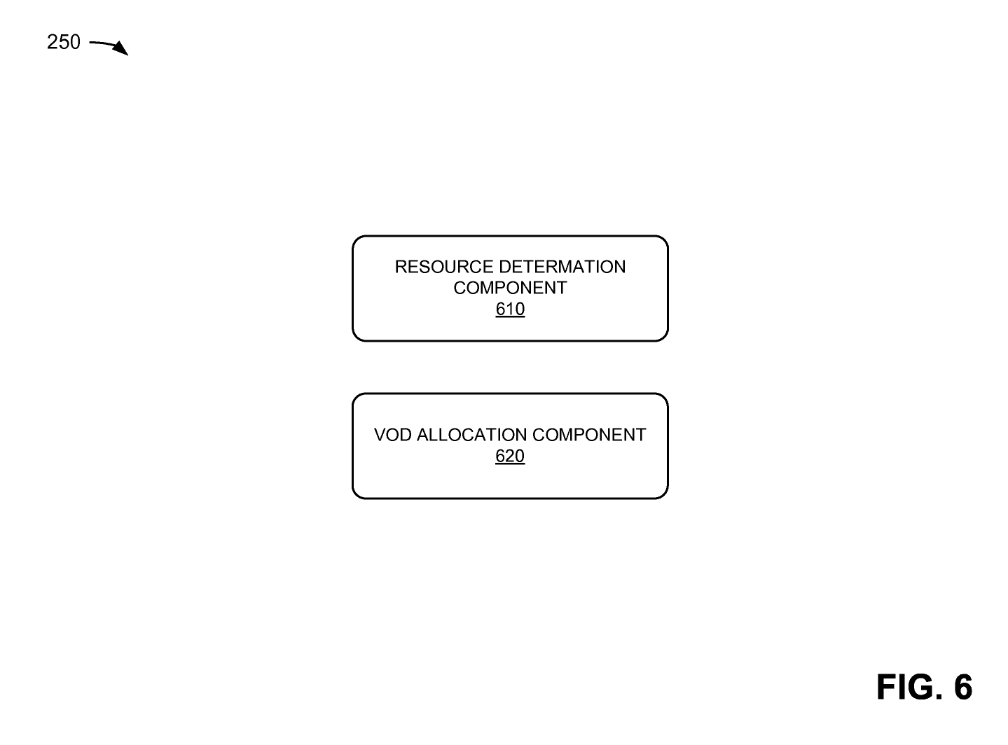

FIG. 6 is a diagram of example functional components of VOD scheduler 250. Each of the functional blocks, shown in FIG. 6, may be implemented by one or more of the components described with regard to FIG. 5 (e.g., by processing unit 520 executing instructions stored in memory 530). As shown in FIG. 6, VOD scheduler 250 may include a resource determination component 610 and a VOD allocation component 620.

Resource determination component 610 may receive radio resource availability information from a group of eNodeBs 220 and determine, based on the received information, whether one or more eNodeBs 220, in the group of eNodeBs 220, should be configured to provide VOD broadcast services. As indicated above, radio resource availability information may be information that is determined by eNodeBs 220 and sent to VOD scheduler 250 or may be information that has been averaged over a time period. As one example, assume that VOD scheduler 250 is associated with four eNodeBs 220 and that resource determination component 610 receives a first indication that a first eNodeB 220 has 50% of its radio resources available, a second indication that a second eNodeB 220 has 60% of its radio resources available, a third indication that a third eNodeB 220 has 50% of its radio resources available, and a fourth indication that a fourth eNodeB 220 has 55% of its radio resources available. VOD scheduler 250 may determine, based on the first indication, the second indication, the third indication, and the fourth indication, an amount of radio resources to dedicate to VOD broadcast services. In the example above, VOD scheduler 250 may determine the amount of radio resources for eNodeBs 220 to be a value below the lowest indication, such as 40%. Other ways of determining the amount of radio resources to allocate to VOD broadcast services may alternatively be used. For example, VOD scheduler 250 may make radio resource allocation decisions based on other or additional information, such as information received from customer premises 210.

VOD allocation component 620 may determine radio resources for particular VOD content to be broadcast by eNodeB 220. In one example, VOD allocation component 620 may receive information from customer premises 210 (via eNodeB 220), such as the marketing data described above, and determine radio resources that are to be allocated to particular VOD content to be broadcast by eNodeB 220, based on the received information. For example, if the marketing data indicates that a particular movie is very popular (e.g., based on the quantity of customer premises 210 that have ordered the particular movie), VOD allocation component 620 may allocate a higher data rate for the particular movie, as compared to the data rate allocated to a less popular movie.

Although FIG. 6 shows example functional components of VOD scheduler 250, in other implementations, VOD scheduler 250 may include additional functional components, different functional components, and/or fewer functional components than those depicted in FIG. 6. Additionally, or alternatively, one or more functional components of VOD scheduler 250 may perform one or more tasks described as being performed by one or more other functional components of VOD scheduler 250.

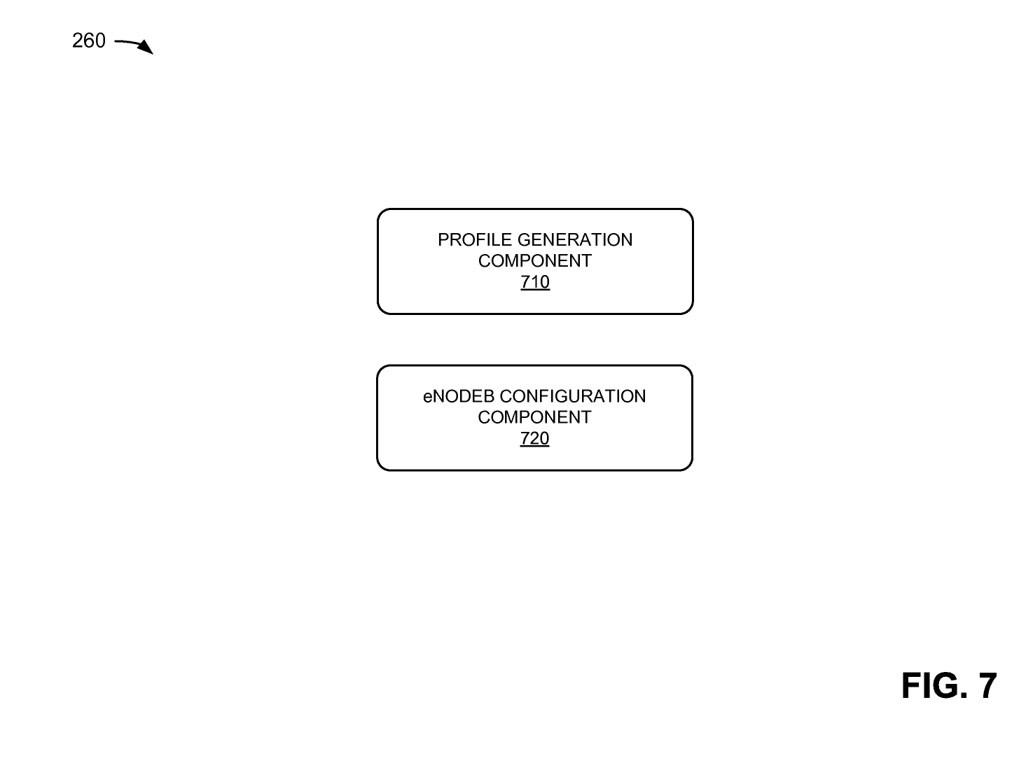

FIG. 7 is a diagram of example functional components of BVPS 260. Each of the functional blocks, shown in FIG. 7, may be implemented by one or more of the components described with regard to FIG. 5 (e.g., by processing unit 520 executing instructions stored in memory 530). As shown in FIG. 7, BVPS 260 may include a profile generation component 710 and an eNodeB configuration component 720.

Profile generation component 710 may generate configuration profiles for configuring eNodeB 220. In one example, profile generation component 710 may receive radio resource availability information from VOD scheduler 250 and generate a configuration profile for eNodeB 220 based on the configuration profile. The configuration profile may include enough information to allow eNodeB 220 to be configured for a VOD broadcast service. For example, the configuration profile may include information that indicates the amount of radio resources that are to be allocated to a VOD broadcast service, a time at which the VOD broadcast service is to begin, and a time at which the VOD broadcast service is to end. In some instances, profile generation component 710 may generate and store configuration profiles in an off-line process. In these instances, profile generation component 710 may receive the radio resource availability information from VOD scheduler 250 and select a previously-generated configuration profile for configuring eNodeB 220 for the VOD broadcast service.

eNodeB configuration component 720 may receive a configuration profile from profile generation component 710 and send the configuration profile to eNodeB 220 to configure eNodeB 220 for the VOD broadcast service. eNode B 220 may receive the configuration profile and allocate, at or before the specified time, the specified amount of radio resources for the VOD broadcast service.

Although FIG. 7 shows example functional components of BVPS 260, in other implementations, BVPS 260 may include additional functional components, different functional components, and/or fewer functional components than those depicted in FIG. 7. Additionally, or alternatively, one or more functional components of BVPS 260 may perform one or more tasks described as being performed by one or more other functional components of BVPS 260.

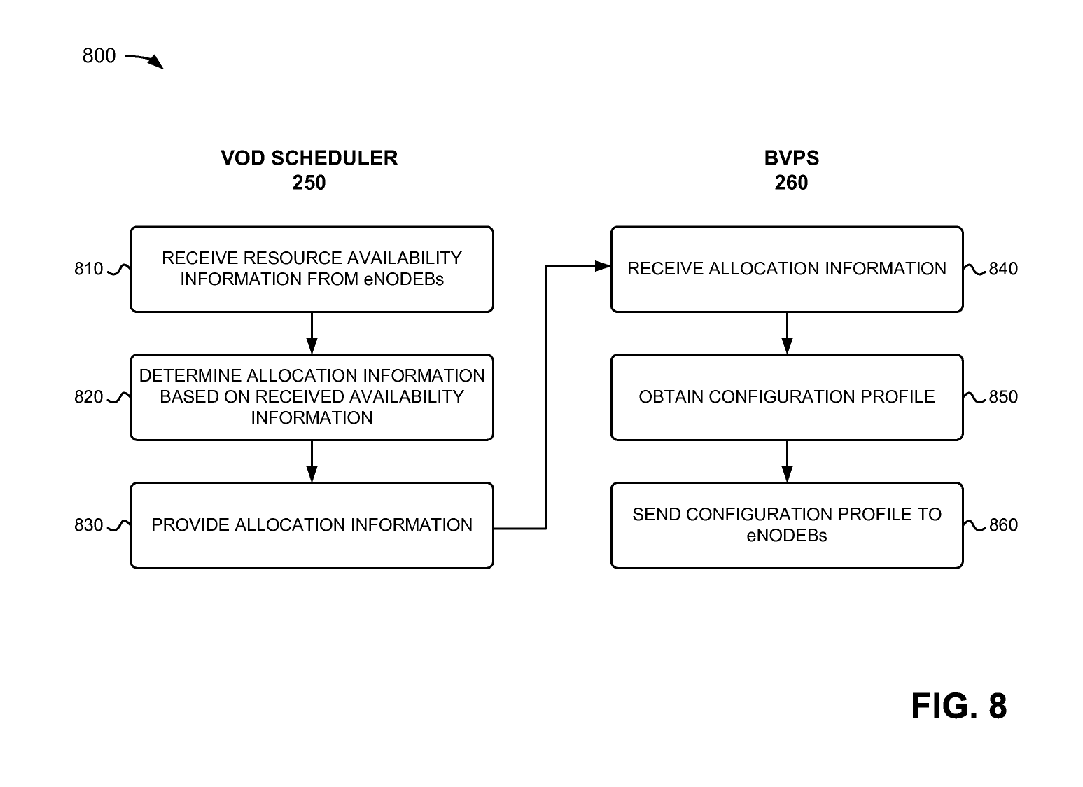

FIG. 8 is a diagram of a flow chart of an example process 800 for configuring an eNodeB to provide VOD broadcast services. In one example implementation, process 800 may be performed by VOD scheduler 250 and BVPS 260. Additionally, or alternatively, some or all of process 800 may be performed by another device or group of devices, including or excluding VOD 250 and BVPS 260.

As shown in FIG. 8, process 800 may include receiving resource availability information from a group of eNodeBs (block 810). For example, as described above, each eNodeB 220 (e.g., resource availability component 430) may determine the amount of radio resources being used by customer premises 210 (and any mobile users) in the service area of eNodeB 220. eNodeB 220 may determine the amount of available radio resources based on the amount of radio resources being used by eNodeB 220. For example, assume that eNodeB 220 determines that 40% of eNodeB 220's radio resources are being used. eNodeB 220 may determine that 60% of eNodeB 220's radio resources are available. eNodeB 220 may provide, to VOD scheduler 250, an indication that 60% of eNodeB 220's radio resources are available. Each eNodeB 220 may provide radio resource availability information, to VOD scheduler 250, at a periodic interval.

VOD scheduler 250 (e.g., resource determination component 610) may receive radio resource availability information from each eNodeB 220, of the group of eNodeBs 220 associated with VOD scheduler 250. VOD scheduler 250 may store the radio resource availability information.

Process 800 may further include determining allocation information based on the received availability information (block 820). For example, VOD scheduler 250 (e.g., VOD allocation component 620) may analyze the stored radio resource availability information (which, as described above, may include the average amount of radio resources available over a time period), received from the group of eNodeBs 220. VOD scheduler 250 may calculate an amount of radio resources to be allocated to VOD broadcast services based on the analysis. As one example, assume that the group of eNodeBs 220 includes a first eNodeB 220 and a second eNodeB 220. Moreover, assume that VOD scheduler 250 determines, based on previous radio resource availability indications received from these eNodeBs 220, that first eNodeB 220 is likely to have 50% of its radio resources available and second eNodeB 220 is likely to have 60% of its radio resources available during a future time period. VOD scheduler 250 may determine a radio resource allocation for these eNodeBs 220, during the future time period, to be a value less than the lowest radio resource availability of eNodeBs 220. In one example, VOD scheduler 250 may determine the radio resource allocation to be 10%, 20%, or some other percentage less than the lowest value. Therefore, assuming that lowest value is 50% and the percentage is 20%, VOD scheduler 250 may determine the radio resource allocation to be 40%.

Process 800 may further include providing the allocation information (block 830). For example, VOD scheduler 250 (e.g., resource determination component 610) may provide the allocation information to BVPS 260.

As further shown in FIG. 8, process 800 may include receiving the allocation information (block 840), and obtaining a configuration profile (block 850). For example, BVPS 260 (e.g., profile generation component 710) may receive the allocation information from VOD scheduler 250. In the example above, BVPS 260 may receive information indicating that 40% of the radio resources of eNodeB 220 may be allocated to VOD broadcast services. BVPS 260 (e.g., profile generation component 710) may obtain a configuration profile. In one implementation, BVPS 260 may generate a configuration profile based on receiving the allocation information or based on receiving an indication that VOD content is to be broadcast. As indicated above, the configuration profile may instruct eNodeBs 220 to allocate the amount of radio resources, specified by VOD scheduler 250, at a particular start time, and to reallocate the amount of radio resources at a particular end time. Alternatively, BVPS 260 may select a previously-generated configuration profile for configuring eNodeBs 220 for the VOD broadcast service.

Process 800 may include sending the configuration profile to the group of eNodeBs (block 860). For example, BVPS 260 (e.g., eNodeB configuration component 720) may send the configuration profile to eNodeBs 220 and notify BMSC 240 as to the VOD content that is to be broadcast. eNodeBs 220 may receive the configuration profiles and, at or before the appropriate start time, allocate the indicated amount of radio resources to providing VOD broadcast services. eNodeBs 220 may receive the VOD content at or before the appropriate start time and broadcast the VOD content to customer premises 210 that are serviced by the group of eNodeBs 220.

The above blocks may be repeated to allow for reallocation of radio resources to support VOD broadcast services.

Although FIG. 8 shows example blocks of process 800, in other implementations, process 800 may include additional blocks, different blocks, fewer blocks, and/or differently arranged blocks than those depicted in FIG. 8. Additionally, or alternatively, one or more of the blocks of process 800 may be performed in parallel.

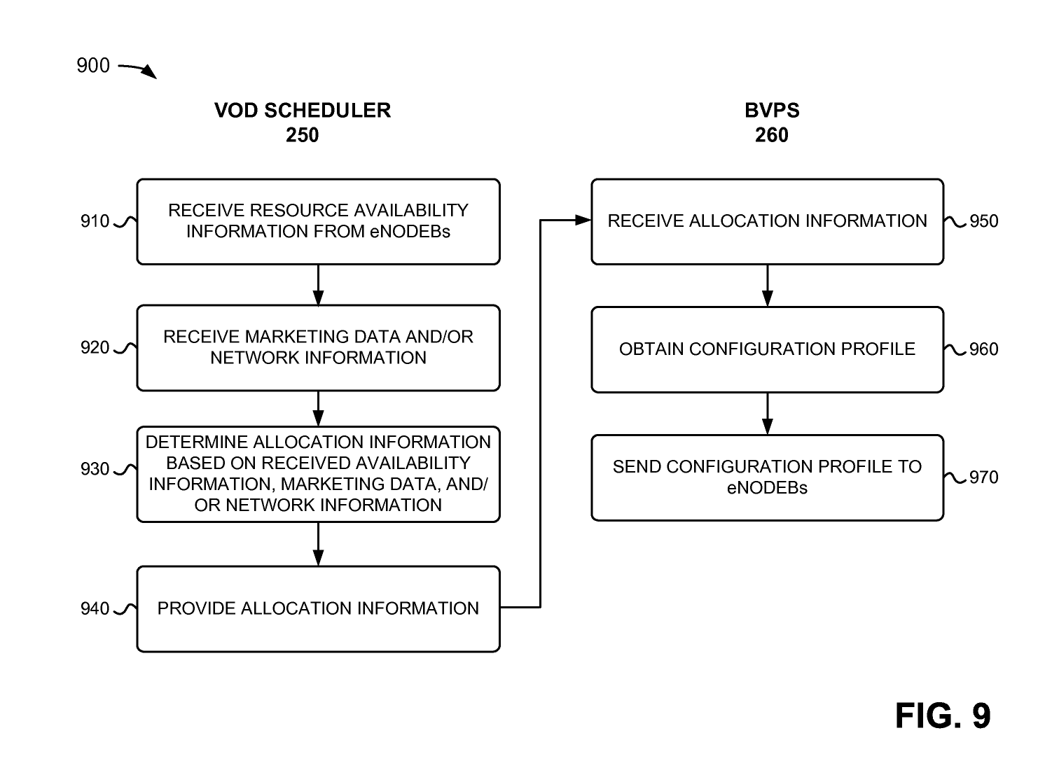

FIG. 9 is a flow chart of another example process 900 for configuring an eNodeB to provide VOD broadcast services. In one example implementation, process 900 may be performed by VOD scheduler 250 and BVPS 260. Additionally, or alternatively, some or all of process 900 may be performed by another device or group of devices, including or excluding VOD 250 and BVPS 260.

As shown in FIG. 9, process 900 may include receiving resource availability information from a group of eNodeBs (block 910). For example, as described above, each eNodeB 220 (e.g., resource availability component 430) may determine the amount of radio resources being used by customer premises 210 (and any mobile users) in the service area of eNodeB 220. eNodeB 220 may determine the amount of available radio resources based on the amount of radio resources being used by eNodeB 220. For example, assume that eNodeB 220 determines that 40% of eNodeB 220's radio resources are being used. In this example, eNodeB 220 may determine that 60% of eNodeB 220's radio resources are available. eNodeB 220 may provide, to VOD scheduler 250, an indication that 60% of eNodeB 220's radio resources are available. Each eNodeB 220 may provide radio resource availability information, to VOD scheduler 250, at a periodic interval.

VOD scheduler 250 (e.g., resource determination component 610) may receive radio resource availability information from each eNodeB 220, of the group of eNodeBs 220 associated with VOD scheduler 250. VOD scheduler 250 may store the radio resource availability information.

Process 900 may further include receiving marketing data and/or network information (block 920). For example, VOD scheduler 250 (e.g., VOD allocation component 620) may receive marketing data and/or network information from customer premises 210 (e.g., via eNodeB 220). The marketing data may include, for example, information relating to VOD content that is available to customer premises 210. For example, the marketing data may include information indicating selections (or ordering) of VOD content, ratings of VOD content, and/or any other type of information that may allow VOD scheduler 250 to determine whether to broadcast particular VOD content and to determine the radio resources that should be dedicated to broadcasting the particular VOD content. The network information may include, for example, a quantity of customer premises 210 served by eNodeB 220 and/or information relating to the radio signals provided to customer premises 220. For example, customer premises 210 may provide, to eNodeB 220, RSSI information, RSRP information, SINR information, and/or other network information that would allow VOD scheduler 250 to determine whether a particular eNodeB 220 should broadcast VOD content. VOD scheduler 250 may receive the marketing data and network information from eNodeB 220.

Process 900 may further include determining allocation information based on the received availability information, the marketing data, and/or the network information (block 930). For example, VOD scheduler 250 (e.g., VOD allocation component 620) may analyze the stored radio resource availability information, received from the group of eNodeBs 220, and calculate an amount of radio resources to be allocated to the group of eNodeBs 220 based on the analysis, as described above with respect to block 820 of FIG. 8.

In addition, VOD scheduler 250 may, based on analyzing the stored radio resource availability information from the group of eNodeBs 220, determine a time period that may be best suited for VOD broadcasts. For example, based on analyzing the stored radio resource availability information, VOD scheduler 250 may identify off-peak hours for VOD broadcasts (e.g., time period(s) where minimum radio resources are typically being used by the group of eNodeBs 220). For example, the off-peak hours may correspond to midnight to 5 am or some other time period. During the off-peak hours, VOD scheduler 250 may schedule the broadcast of additional VOD content that may, for example, be stored (e.g., in a hard drive) at customer premises 210 for later viewing. In this situation, eNodeBs 220 may provide customer premises 210 with a list of possible VOD content (e.g., as part of the ESG) that may be downloaded during those off-peak hours. In this way, customer premises 210 may be presented with greater opportunities to enjoy VOD broadcasts.

Additionally, or alternatively, VOD scheduler 250 may determine allocation information based on the marketing data received from the group of eNodeBs 220. For example, VOD scheduler 250 (e.g., VOD allocation component 620) may determine a quality of service to be associated with the particular VOD content based on the marketing data. As one example, assume that two different VOD events are to be broadcast from the group of eNodeBs 220 and that the marketing data indicates that one of the VOD events is much more popular than the other VOD event. In this situation, VOD scheduler 250 may determine that a higher data rate (e.g., 3 megabits per second) is to be associated with the more popular VOD event and a lower data rate (e.g., 1.5 megabits per second) is to be associated with the less popular VOD event.

Additionally, or alternatively, VOD scheduler 250 may determine allocation information based on the network information received from the group of eNodeBs 220. For example, VOD scheduler 250 may make radio resource allocation decisions based on a quantity of customer premises 210 that have ordered particular VOD content to be broadcast. As one example, assume that a particular VOD event is to be broadcast on a particular date. Assume further that, while the VOD event is very popular with respect to the group of eNodeBs 220, no customer premises 210 in the service area of one particular eNodeB 220, of the group of eNodeBs 220, ordered the VOD event. In this situation, VOD scheduler 250 may determine that all radio resources, of the one particular eNodeB 220, are to be allocated to unicast services during the time period when the other eNodeBs 220 are allocated to broadcasting the VOD event. Additionally, or alternatively, if a small number of customer premises 210, being serviced by a particular eNodeB 220, has ordered the VOD event, VOD scheduler 250 may determine whether the small number of customer premises 210 are also serviced by another eNodeB 220. In those situations in which the small number of customer premises 210 are also serviced by another eNodeB 220, VOD scheduler 260 may also determine that all radio resources, of the one particular eNodeB 220, are to be allocated to unicast services during the time period when the other eNodeBs 220 are allocated to broadcasting the VOD event.

Additionally, or alternatively, VOD scheduler 250 may determine additional allocation information based on the network information received from the group of eNodeBs 220. For example, VOD scheduler 250 may make radio resource allocation decisions based on radio frequency conditions associated with customer premises 210. As one example, assume that eNodeB 220 receives information identifying the radio frequency conditions (e.g., RSSI information, RSRP information, and/or SINR information) from a group of customer premises 210 being served by eNodeB 220. eNodeB 220 may forward that information to VOD scheduler 250. VOD scheduler 250 may determine that the broadcast of VOD content is only to be made available to those customer premises 220 that meet a minimum set of radio frequency requirements (e.g., those customer premises 220 that have a minimum RSSI, a minimum RSRP, and/or a minimum SINR). In this situation, information may be provided to customer premises 210 to configure customer premises 210 to only obtain the broadcast if the customer premises 210 meets that minimum set of radio frequency requirements. Additionally, or alternatively, if no customer premises 210, associated with a particular eNodeB 220, meet the minimum set of radio frequency requirements, all of the particular eNodeB 220's radio resources may be allocated to providing unicast services, during the time that the VOD content is being broadcast.

Additionally, or alternatively, VOD scheduler 250 may use the received information identifying radio frequency conditions to more precisely match the most suitable radio configuration (e.g., the most suitable number of subframes to use, the most suitable modulation and coding scheme to use, the most suitable forward error correction (FEC) parameters to use, etc.) for the broadcast service area. In this way, eNodeB 220's radio resources may be better utilized for VOD broadcasts.

Process 900 may further include providing the allocation information (block 940). For example, VOD scheduler 250 (e.g., resource determination component 610) may provide the allocation information to BVPS 260.

As further shown in FIG. 9, process 900 may include receiving the allocation information (block 950), and obtaining a configuration profile (block 960). For example, BVPS 260 (e.g., profile generation component 710) may receive the allocation information from VOD scheduler 250. As indicated above, the allocation information may include information identifying an amount of radio resources to allocate for a VOD broadcast, which may be specified for a group of eNodeBs 220 or on a per-eNodeB 220 basis, information identifying an amount of radio resources to allocate for VOD broadcasts on a per VOD content basis, information identifying which customer premises 210 are to be offered VOD broadcast services (e.g., based on radio frequency condition information received from customer premises 210), and/or other information. BVPS 260 (e.g., profile generation component 710) may obtain a configuration profile. In one implementation, BVPS 260 may generate a configuration profile based on receiving the allocation information or based on receiving an indication that VOD content is to be broadcast. The configuration profile may instruct eNodeBs 220 to allocate the amount of radio resources, based on some or all of the allocation information received from VOD scheduler 250, at a particular start time, and to reallocate the amount of radio resources at a particular end time. Alternatively, BVPS 260 may select a previously-generated configuration profile for configuration eNodeBs.

Process 900 may include sending the configuration profile to the group of eNodeBs (block 970). For example, BVPS 260 (e.g., eNodeB configuration component 720) may send the configuration profile to eNodeBs 220 and notify BMSC 240 to provide the VOD content to eNodeBs 220. eNodeBs 220 may receive the configuration profiles and, at the appropriate start time, allocate the indicated amount of radio resources to providing broadband services. eNodeBs 220 may receive the VOD content at or before the appropriate start time and broadcast the VOD content to customer premises 210 that are serviced by the group of eNodeBs 220.

The above blocks may be repeated to allow for reallocation of radio resources to support VOD broadcast services.

Although FIG. 9 shows example blocks of process 900, in other implementations, process 900 may include additional blocks, different blocks, fewer blocks, and/or differently arranged blocks than those depicted in FIG. 9. Additionally, or alternatively, one or more of the blocks of process 900 may be performed in parallel.

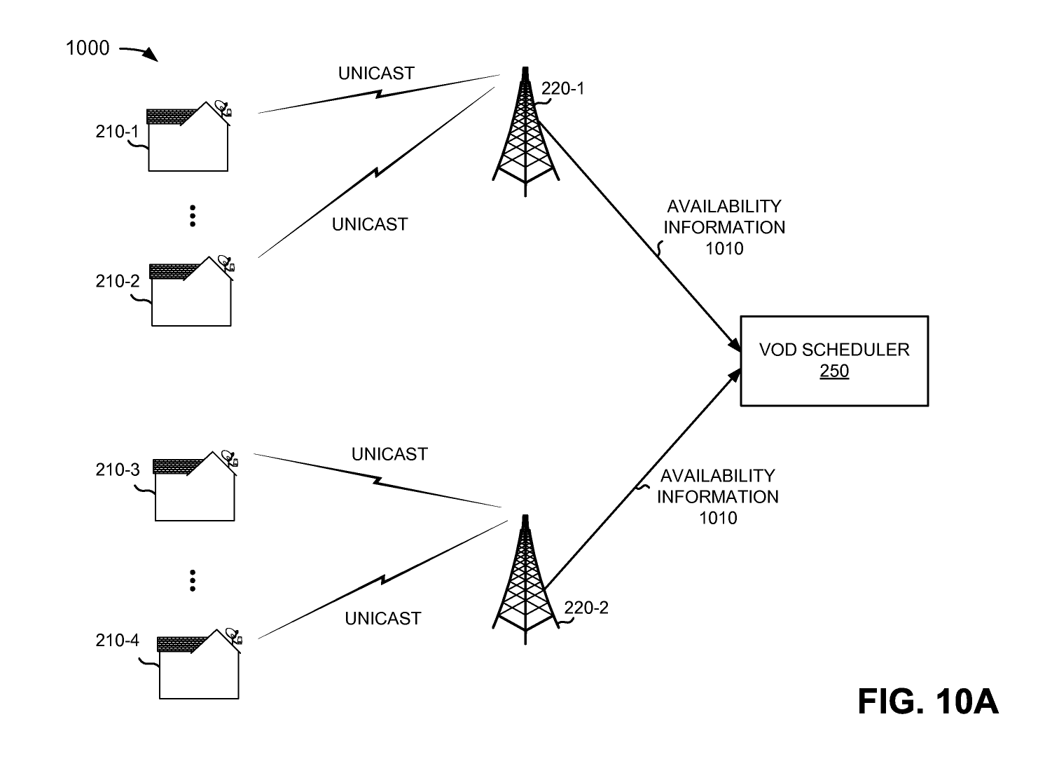

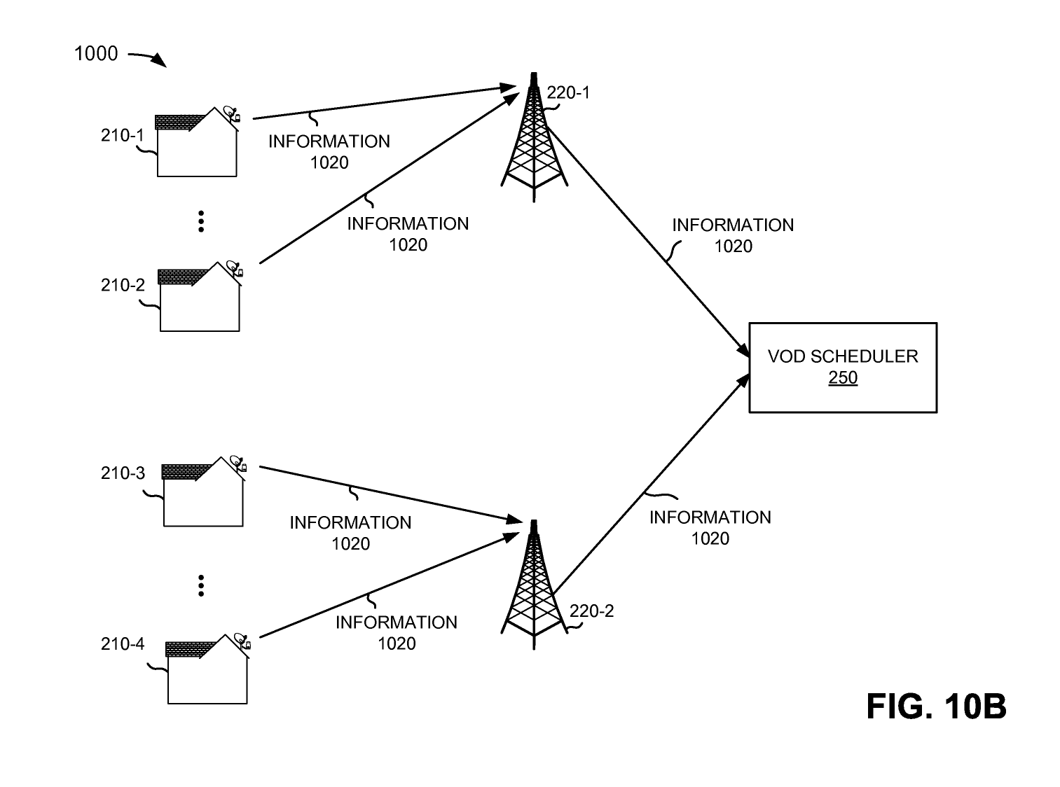

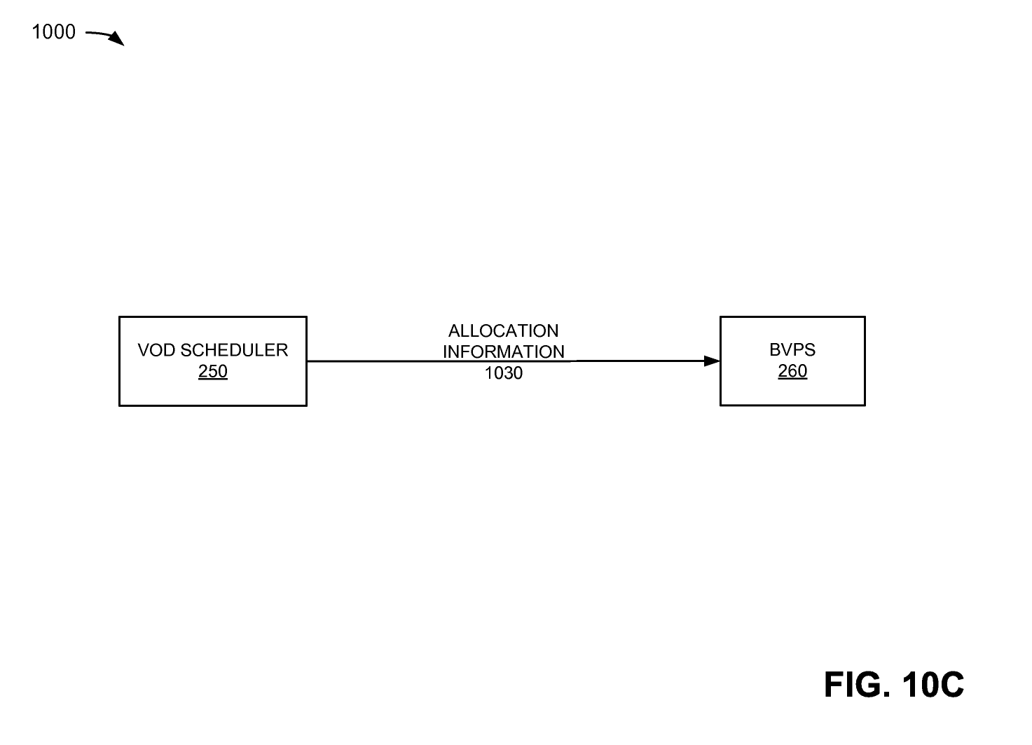

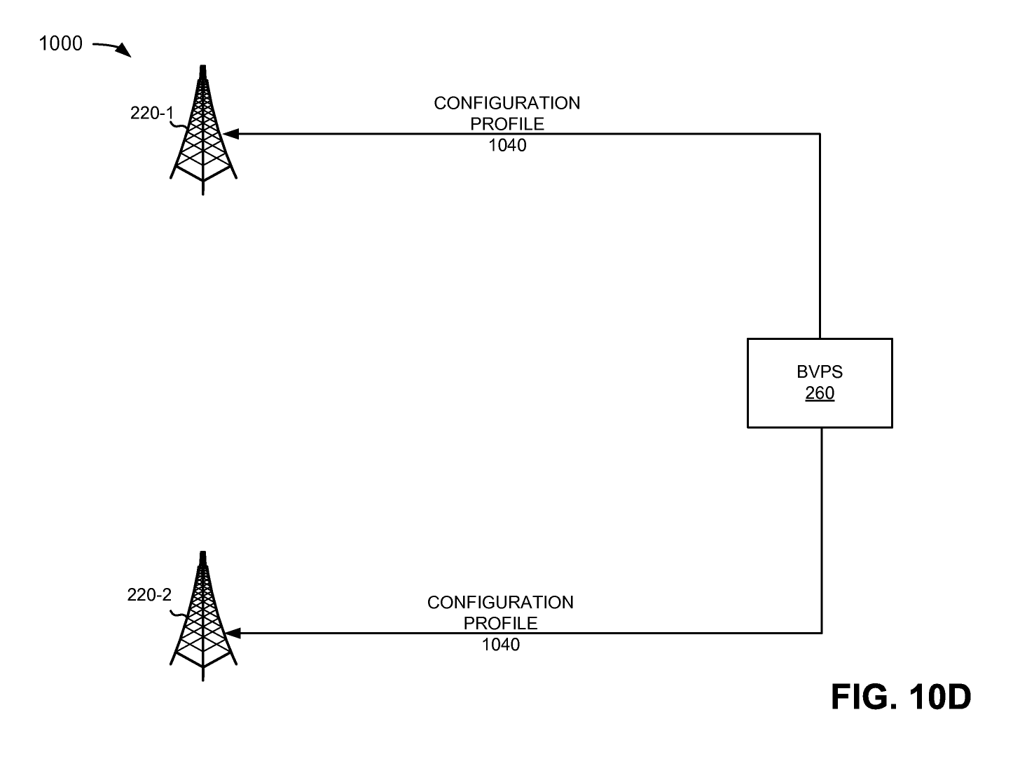

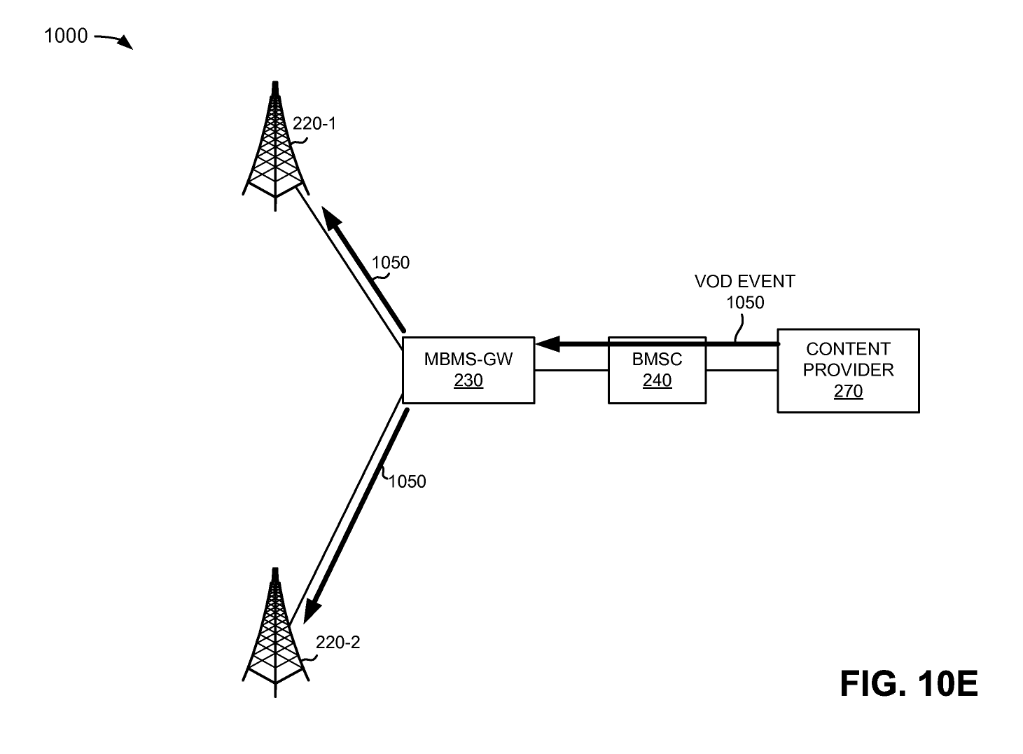

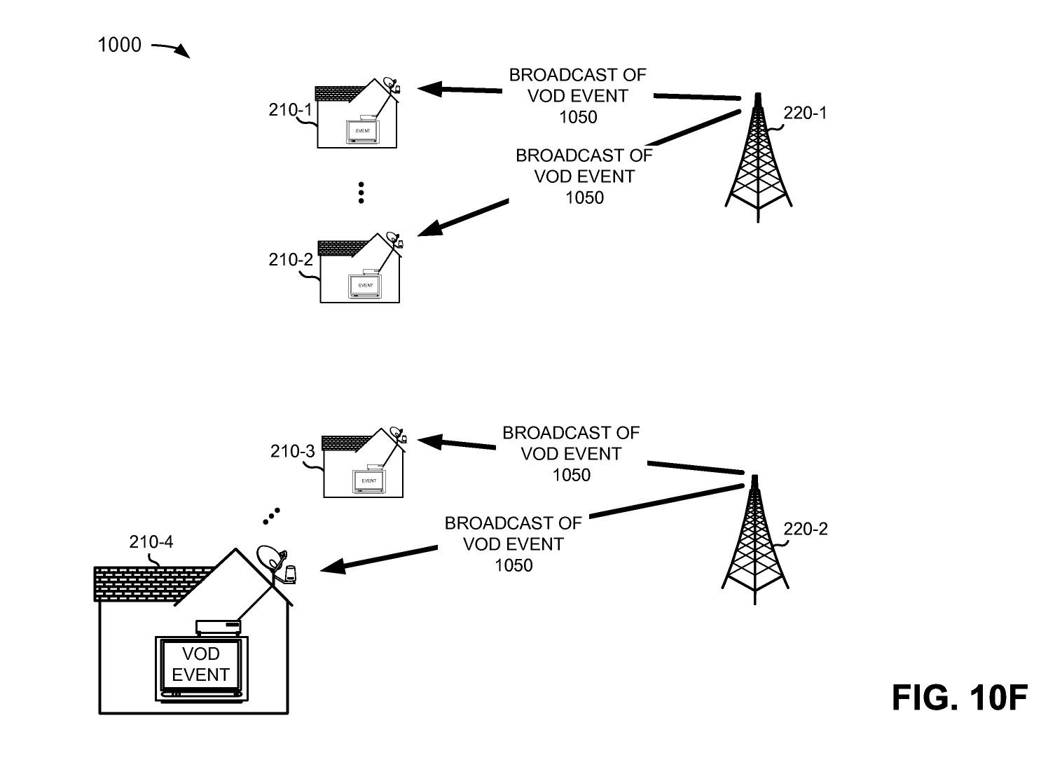

FIGS. 10A-10F are diagrams illustrating an example 1000 of process 900. In example 1000, assume that VOD scheduler 250 is associated with two eNodeBs 220 (shown as eNodeB 220-1 and eNodeB 220-2), which provide unicast services and VOD broadcast services to customer premises 210. For example, eNodeB 220-1 may provide unicast services and VOD broadcast services to a group of customer premises 210, including customer premises 210-1 and customer premises 210-2. eNodeB 220-2 may provide unicast services and VOD broadcast services to a group of customer premises 210, including customer premises 210-3 and customer premises 210-4. Assume further that each customer premises 210-1, 210-2, 210-3, and 210-4 ordered particular VOD content (called “VOD EVENT”) that is to be broadcast on Saturday night at 9 pm.

As shown in FIG. 10A, eNodeBs 220 may provide availability information 1010 to VOD scheduler 250. Availability information 1010 may indicate, for example, the percentage of the respective eNodeB 220's radio resources that are available. eNodeBs 220 may provide availability information 1010, to VOD scheduler 250, at a periodic interval, such as every 5 minutes.

As shown in FIG. 10B, eNodeBs 220 may receive information 1020 from customer premises 210 on a periodic interval. Information 1020 may include, for example, information identifying that the particular customer premises 210 has ordered the VOD EVENT, information identifying radio frequency conditions (e.g., RSSI information, RSRP information, SINR information, etc.) associated with the particular customer premises 210, and/or other type of information that may be used to allocate radio resources for broadcasting the VOD EVENT. As further shown in FIG. 10B, eNodeBs 220 may send information 1020 to VOD scheduler 250. eNodeBs 220 may send information 1020 in response to receiving information 1020, at the same time that availability information 1010 is sent, or at another time.

With reference to FIG. 10C, VOD scheduler 250 may generate allocation information 1030 based on availability information 1010, information 1020, and possibly previously-stored availability information 1010 and previously-stored information 1020. Allocation information 1030 may indicate a percentage of radio resources that eNodeBs 220 are to use for the VOD EVENT. The allocation of radio resources at eNodeB 220-1 may be the same as or different from the allocation of radio resources at eNodeB 220-2. In some instances, for example, allocation information 1030 may indicate that only eNodeB 220-1 is to broadcast the VOD EVENT, while eNodeB 220-2 is to continue to provide only unicast services (e.g., when no customer premises 210, associated with eNodeB 220-2, has ordered the VOD EVENT).

Allocation information 1030 may additionally, or alternatively, indicate a particular level of video quality at which the VOD EVENT is to be broadcast. For example, allocation information 1030 may indicate that the VOD EVENT, due, for example, to its popularity, is to be broadcast at a data rate that is higher than other VOD content that is less popular.

Allocation information 1030 may additionally, or alternatively, indicate which customer premises 210 are to receive the VOD EVENT broadcast. For example, VOD scheduler 250 may indicate, in allocation information 1030, that only those customer premises 210 that have radio frequency conditions above some threshold (e.g., above a RSSI minimum threshold, above a RSPR minimum threshold, above a SINR minimum threshold, etc.) are to receive the VOD EVENT broadcast.

Allocation information 1030 may additionally, or alternatively, indicate a particular radio configuration to be used to broadcast the VOD EVENT. For example, VOD scheduler 250 may indicate, in allocation information 1030, that a particular number of subframes are to be used for broadcasting the VOD EVENT, that a particular modulation and coding scheme is to be used for broadcasting the VOD EVENT, and/or that a particular FEC parameter is to be used for broadcasting the VOD EVENT.

As shown in FIG. 10C, VOD scheduler 250 may provide allocation information 1030 to BVPS 260. With reference to FIG. 10D, BVPS 260 may receive allocation information 1030 and obtain a configuration profile 1040 based on allocation information 1030. Configuration profile 1040 may instruct eNodeB 220-1 and eNodeB 220-2 as to the radio resources that are to be allocated to the broadcast of the VOD EVENT. In addition, configuration profile 1040 may indicate, to eNodeB 220-1 and eNodeB 220-2, the time at which the VOD EVENT broadcast is to begin and when the broadcast is to end. In example 1000, configuration profile 1040 may indicate, to eNodeB 220-1 and eNodeB 220-2, that radio resources are to be allocated to the broadcast at some time period before the start of the broadcast (e.g., 15 minutes or some other time before the start of the broadcast). As illustrated in FIG. 10D, BVPS 260 may provide configuration profile 1040 to eNodeB 220-1 and eNodeB 220-2 and eNodeB 220-1 and eNodeB 220-2 may configure radio resources, at the appropriate time and in accordance with configuration profile 1040.

With reference to FIG. 10E, content provider 270 may provide VOD EVENT 1050 to eNodeB 220-1 and eNodeB 220-2 at some time period before the start of the broadcast. In example 1000, assume that VOD EVENT is provided to eNodeB 220-1 and eNodeB 220-2 at least 15 minutes before VOD EVENT 1050 is to be broadcast and that eNodeB 220-1 and eNodeB 220-2 store VOD EVENT 1050 (e.g., in memory 334).

Finally, with reference to FIG. 10F, eNodeB 220-1 and eNodeB 220-2 may begin streaming VOD EVENT 1050 at the scheduled day and time (i.e., Saturday night at 9 pm). Customer premises 210 may receive the broadcast of VOD EVENT 1050 and provide VOD EVENT 1050 for display, as shown in FIG. 10F.

Systems and/or methods described herein may provide VOD broadcasts in a wireless environment. The decisions as to what radio resources are to be allocated to the VOD broadcasts may be based on radio resource availability of the base stations providing the VOD broadcasts. The decisions may further be based on information from the fixed wireless devices to which the VOD broadcasts are destined.

The foregoing description of implementations provides illustration and description, but is not intended to be exhaustive or to limit the implementations to the precise form disclosed. Modifications and variations are possible in light of the above teachings or may be acquired from practice of the implementations.

For example, while the above description focused on providing VOD broadcast services to fixed wireless customer premises, the VOD broadcast services may be equally extended to non-fixed wireless devices (e.g., subscribers using tablets or smartphones). In one implementation, the ability of a non-fixed wireless device to receive VOD broadcast services may be based on the device's radio frequency conditions. For example, a minimum set of RSPR and SINR conditions may need to be met for the non-fixed wireless device to receive VOD broadcast services. In these situations, the tablets or smartphones may include a visual indicator (e.g., similar to an icon in smartphones displaying 1 to 4 bars, depending on signal strength), which could allow the subscriber to know whether radio frequency conditions are suitable for receiving and consuming VOD broadcast services at the non-fixed wireless device's current location.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

The term “component,” as used herein, is intended to be broadly construed to include hardware (e.g., a processor, a microprocessor, an application-specific integrated circuit (ASIC), a field-programmable gate array (FPGA), a chip, a memory device (e.g., a read only memory (ROM), a random access memory (RAM), etc.), etc.) or a combination of hardware and software (e.g., a processor, microprocessor, ASIC, etc. executing software contained in a memory device).

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by one or more devices and from a base station, information identifying a quantity of available radio resources at the base station;
determining, by the one or more devices and based on the received information, a quantity of radio resources to be allocated to a video on demand broadcast service;
obtaining, by the one or more devices, a configuration profile, the configuration profile including information for instructing the base station to allocate the determined quantity of radio resources to the video on demand broadcast service at a particular time; and
sending, by the one or more devices, the configuration profile to the base station before the particular time.

2. The method of claim 1, where the base station provides the video on demand broadcast service to a group of fixed wireless devices,
where the method further comprises:
receiving information from the group of fixed wireless devices, and
where the configuration profile includes information relating to the information received from the group of fixed wireless devices.

3. The method of claim 2, where the information received from the group of fixed wireless devices includes information relating to selections of video on demand content that is to be broadcast as part of the video on demand broadcast service, and
where the configuration information includes a data rate at which the video on demand content is to be provided, by the base station, based on the information relating to selections of the video on demand content.

4. The method of claim 3, further comprising:
receiving second information from a second group of fixed wireless devices, the second group of fixed wireless devices being served by a second base station that is different than the base station, the second information indicating that no fixed wireless device, in the second group of fixed wireless devices, selected the video on demand content; and
determining not to send the configuration profile to the second base station based on receiving the second information.

5. The method of claim 2, where the information received from the group of fixed wireless devices includes information relating to radio signals received from the base station, and
where the obtaining the configuration profile includes:
determining configuration information based on the information relating to the radio signals, the configuration information including at least one of:
information relating to a number of subframes to use for the video on demand broadcast service,
information relating to a modulation and coding scheme to use for the video on demand broadcast service, or
information relating to a forward error correction (FEC) parameter to use for the video on demand broadcast service, and
storing the determined configuration information in the configuration profile.

6. The method of claim 1, where the configuration profile further includes a time at which the video on demand broadcast services is to end, and
where the base station allocates the determined quantity of radio resources to a unicast service after the time at which the video on demand broadcast is to end.

7. The method of claim 1, where the particular time is a beginning of an off-peak time period.

8. A system comprising:
one or more devices to:
obtain indications of quantities of wireless resources that are available at a group of wireless transmission devices,
determine, based on the obtained indications, an amount of wireless resources to allocate to a broadcast service that provides video on demand content, and
cause the determined amount of wireless resources to be allocated, from a unicast service, to the broadcast service at one or more wireless transmission devices, of the group of wireless transmission devices.

9. The system of claim 8, where the group of wireless transmission devices includes:
a plurality of eNodeBs.

10. The system of claim 8, where, when obtaining the indications, the one or more devices are to:
receive the indications from the group of wireless transmission devices at a periodic interval.

11. The system of claim 8, where, when determining the amount of wireless resources to allocate, the one or more devices are to:
identify a smallest amount of wireless resources available at the group of wireless transmission devices based on the obtained indications, and
determine the amount of wireless resources to allocate based on the smallest amount.

12. The system of claim 8, where, when causing the determined amount, the one or more devices are to:
send, to the one or more wireless transmission devices, information indicating that the one or more wireless transmission devices are to allocate the determined amount of wireless resources at a particular time.

13. The system of claim 12, where the particular time is prior to a time at which the one or more wireless transmission devices are to broadcast the video on demand content.

14. The system of claim 8, where the one or more wireless transmission devices includes less than all of the wireless transmission devices in the group of wireless transmission devices.

15. The system of claim 8, where the one or more wireless transmission devices includes all of the wireless transmission devices in the group of wireless transmission devices.

16. The system of claim 8, where the one or more wireless transmission devices provide the broadcast service to a group of wireless devices, and
where the one or more devices are further to:
receive information from the group of wireless devices,
determine, based on the received information, a data rate at which the video on demand content is to be broadcast, and
cause the one or more wireless transmission devices to broadcast the video on demand content at the determined data rate.

17. The system of claim 8, where the one or more wireless transmission devices provide the broadcast service to a group of wireless devices, and
where the one or more devices are further to:
receive information from the group of wireless devices,
determine, based on the received information, at least one of:
information relating to a number of subframes to use for the broadcast service,
information relating to a modulation and coding scheme to use for the broadcast service, or
information relating to a forward error correction (FEC) parameter to use for the broadcast service, and
cause the one or more wireless transmission devices to broadcast the video on demand content based on the at least one of the information relating to the number of subframes to use for the broadcast service, the information relating to the modulation and coding scheme to use for the broadcast service, or the information relating to the FEC parameter to use for the broadcast service.

18. A method comprising:
obtaining, by one or more devices, indications of quantities of wireless resources that are available at a group of wireless transmission devices, the obtaining occurring at periodic intervals;
determining, by the one or more devices and based on the obtained indications, an amount of wireless resources to allocate to a broadcast service that provides video on demand content;
determining, by the one or more devices and based on the obtained indications, a time period at which the broadcast service is to be provided; and
causing, by the one or more devices, the determined amount of wireless resources to be allocated, at or prior to a beginning of the determined time period, to the broadcast service at one or more wireless transmission devices, of the group of wireless transmission devices.

19. The method of claim 18, where the time period corresponds to an off-peak time period.

20. The method of claim 18, where the one or more wireless transmission devices provide the broadcast service to a group of wireless devices,
where the method further includes:
receiving information from the group of wireless devices, and
where the causing includes:
causing the broadcast service to be provided based on the received information.

21. The method of claim 18, where the indications of quantities of wireless resources include average quantities of wireless resources that are available over a time period.
